(19) United States
(12) Patent Application Publication
(10) Pub. No.: US 2010/0320716 A1
(43) Pub. Date: Dec. 23, 2010

(54) HUMAN-DRIVEN TRAVELING APPARATUS

(76) Inventor: Min Kyung SUNG, Cheonan Si (KR)

Correspondence Address: CHRISTOPHER PAUL MITCHELL, 888 16TH ST., NW, SUITE 800, WASHINGTON, DC, 20006, US

(21) Appl. No.: 12/819,161

(22) Filed: Jun. 18, 2010

(30) Foreign Application Priority Data
Jun. 19, 2009 (KR) 10-2009-0054863

(51) Int. Cl. B62M 1/02

(52) U.S. Cl. 280/210

(57) ABSTRACT

A human-driven traveling apparatus includes, among other features, a pedal assembly driving rear wheels using force inputted from both feet of a user. The pedal assembly includes first and second pedals connected to the frame to be rotatable up/down for the user to press down with both feet, respectively, first and second rotary circular plates rotatably connected to the frame, a first power transmission mechanism transmitting rotational force of the first pedal rotated by the force applied by the user, to the first rotary circular plate, a second power transmission mechanism transmitting rotational force of the second pedal rotated by the force applied by the user, to the second rotary circular shaft, and a third power transmission mechanism transmitting the rotational force of the first and second rotary circular plates to the rear wheels to drive the rear wheel.

### RELATED APPLICATIONS

This application claims priority under 35 U.S.C. §119(e) from Korean Patent Application No. 10-2009-0054863, filed Jun. 19, 2009 in the Korean Intellectual Property Office, which is incorporated herein by reference in its entirety.

### FIELD OF THE INVENTION

Embodiments of the present invention relate to a human-driven traveling apparatus, in detail, a human-driven traveling apparatus that is easy to carry and drive and that a driver may stably ride on in a comfortable position without falling when in motion.

### DESCRIPTION OF RELATED ART

There is a kick board as an example of apparatuses for play or exercise. Kick boards are composed of a step to place one foot, a front wheel disposed at the front portion of the step, a rear wheel disposed at the rear portion of the step, and a handle for steering the front wheel.

Such kick boards are driven by placing and supporting one foot on the step and pushing against the ground with the other foot. Further, the direction of motion is adjusted by steering the front wheel with the handle, depending on circumstances.

Theses kick boards, however, have a structure that is driven by only one foot, such that they have the disadvantage that the effect of exercise concentrates on only the used leg and foot. Therefore, they have a problem that it is difficult to expect uniform effect of exercise throughout the human body due to the disadvantage.

A variety of manual kick boards have been proposed to achieve uniform effect of exercise throughout the human body, in consideration of the problem.

As an example, a “kick board” has been disclosed in Korean Patent Application No. 1-2008-0051018, filed by the present applicant(s).

This technology includes a frame, a front wheel and a rear wheel that are disposed at the front portion and the rear portion of the frame, respectively, a handle for steering the front wheel, and a pedal assembly for driving the rear wheel, using the force transmitted from the user's both feet.

In particular, the pedal assembly includes a first pedal that the user can step on with their left foot, a second pedal that the user can step on with their right foot, a first power transmission mechanism that transmits the force applied to the first pedal to the rear wheel, and a second power transmission mechanism that transmits the force applied to the second pedal to the rear wheel.

The kick board having this configuration is propelled by the force from both feet, such that it has the advantage that both feet and legs can be used. Accordingly, it is possible to expect uniform effect of exercise throughout the human body.

However, since the kick board in the related art has a structure in which the rider should stand, it may have the disadvantage that the rider may get easily tired and exhausted. This potential disadvantage may make long-period traveling difficult. In particular, since the rider should stand, there may be a problem in that feeble or older people, who may be uncomfortable to use the waist, pelvis, knee joints etc., may be unfit for using it.

Further, the kick boards of the related art may be disadvantageous in that they may be inconvenient to store, because they may be large in size. In particular, when it is required to move a long distance with the kick board in a vehicle, a potential problem has been indicated in that it may be very inconvenient to put the kick board in the vehicle due to the large size of the kick board.

Further, there may be a disadvantage that the rotational angle of the pedal may be too large in the kick boards of the related arts, such that the pedals may be lifted too high. In particular, since the pedals may be lifted too high, it may be inconvenient for the user to press down the pedals.

### SUMMARY OF THE INVENTION

Embodiments of the present invention address the problems of the related art and it is an aspect of the present invention to provide a human-driven traveling apparatus for a user to travel on for a long period of time in a stable position by providing a configuration for the user to sit.

It is another aspect of the present invention to provide a human-driven traveling apparatus that is more comfortable for feeble or older people by providing a structure that can be propelled by the user sitting thereon.

It is another aspect of the present invention to provide a human-driven traveling apparatus that can be easily carried and stored by providing a structure that can be folded into a minimum size, if needed.

It is another aspect of the present invention to provide a human-driven traveling apparatus that can be driven by rotating small pedals.

It is another aspect of the present invention to provide a human-driven traveling apparatus that makes it possible to decrease the height that the pedals move up and increase the ease with which the pedals are pressed down, because the apparatus can be driven by rotating small pedals.

In order to achieve the above and other aspects of the present invention, a human-driven traveling apparatus may include: a frame; a front wheel disposed at the front portion of the frame; a handle for steering the front wheel; rear wheels disposed at the rear portion of the frame; and a pedal assembly driving the rear wheels, using force inputted from both feet of a user, in which the pedal assembly includes: first and second pedals connected to the frame to be rotatable up/down for the user to presses down with both feet, respectively; first and second rotary circular plates rotatably connected to the frame; a first power transmission mechanism transmitting rotational force of the first pedal rotated by the force applied by the user, to the first rotary circular plate; a second power transmission mechanism transmitting rotational force of the second pedal rotated by the force applied by the user, to the second rotary circular shaft; and a third power transmission mechanism transmitting the rotational force of the first and second rotary circular plates to the rear wheels to drive the rear wheel.

The first power transmission mechanism may include: an arm extending from the rotary shaft-sided portion of the first pedal to rotate with the first pedal; and a link member connecting the arm with the first rotary circular plate to rotate the first rotary circular plate while being pulled by the arm rotating with the first pedal.

Further, the second power transmission mechanism may include: an arm extending from the rotary shaft-sided portion of the second pedal to rotate with the second pedal; and a link member connecting the arm with the second rotary circular plate to rotate the second rotary circular plate while being pulled by the arm rotating with the second pedal.

Further, the first rotary circular plate and the second rotary circular plate may include the same rotational center shafts to rotate with each other, and the third power transmission mechanism may include sprocket teeth formed around any one of the first and second rotary circular plate, a driven sprocket fitted on a wheel shaft for the rear wheels, and a chain linking the sprocket teeth with the driven sprocket.

Further, the first power transmission mechanism and the second power transmission mechanism may be bendable.

Since the human-driven traveling apparatus of at least an embodiment of the present invention may include a pair of rear wheel, it may be stably supported against the ground. Therefore, it may be possible to travel in a more stable position and safely travel without falling when traveling.

Further, since the human-driven traveling apparatus of at least an embodiment of the present invention may include a structure for a user to sit thereon, it may be possible for the rider to travel for a long period of time in a more comfortable position.

Further, since the human-driven traveling apparatus of at least an embodiment of the present invention may include a structure for feeble or older people to safely travel on, sitting thereon, it is very suitable for feeble or the old and weak people to use.

Further, since the human-driven traveling apparatus of at least one embodiment of the present invention may include a structure that may be folded into a minimum size, if needed, it can be easily carried and stored, and also easily carried by vehicles.

Further, since the human-driven traveling apparatus of at least one embodiment of the present invention may include a structure including bendable link members of the first power transmission mechanism and the second power transmission mechanism which transmit force from the pedals to the rear wheels, it may be driven by rotating small pedals. Therefore, it may be possible to decrease the height that the pedals move up and increase the ease with which the pedals are pressed down.

### BRIEF DESCRIPTION OF THE DRAWINGS

FIG. 1 is a perspective view showing the configuration of a human-driven traveling apparatus according to at least one embodiment of the present invention.

FIG. 2 is a side view showing the configuration of the human-driven traveling apparatus according to at least one embodiment of the present invention.

FIG. 3 is a perspective view showing in detail the pedal assembly of the human-driven traveling apparatus according to at least one embodiment of the present invention.

FIG. 4 is a side view showing in detail the pedal assembly of the human-driven traveling apparatus according to at least one embodiment of the present invention.

FIG. 5 is a side view showing when the handle and the seat of the human-driven traveling apparatus of at least one embodiment of the present invention are folded.

FIG. 6 is a perspective view showing another embodiment of a human-driven traveling apparatus.

### DETAILED DESCRIPTION OF THE INVENTION

Preferred embodiments of a human-driven traveling apparatus according to the present invention are described hereafter in detail with reference to the accompanying drawings.

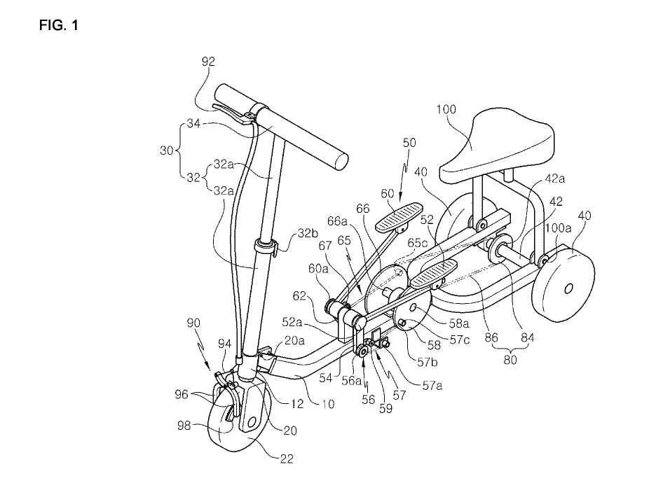

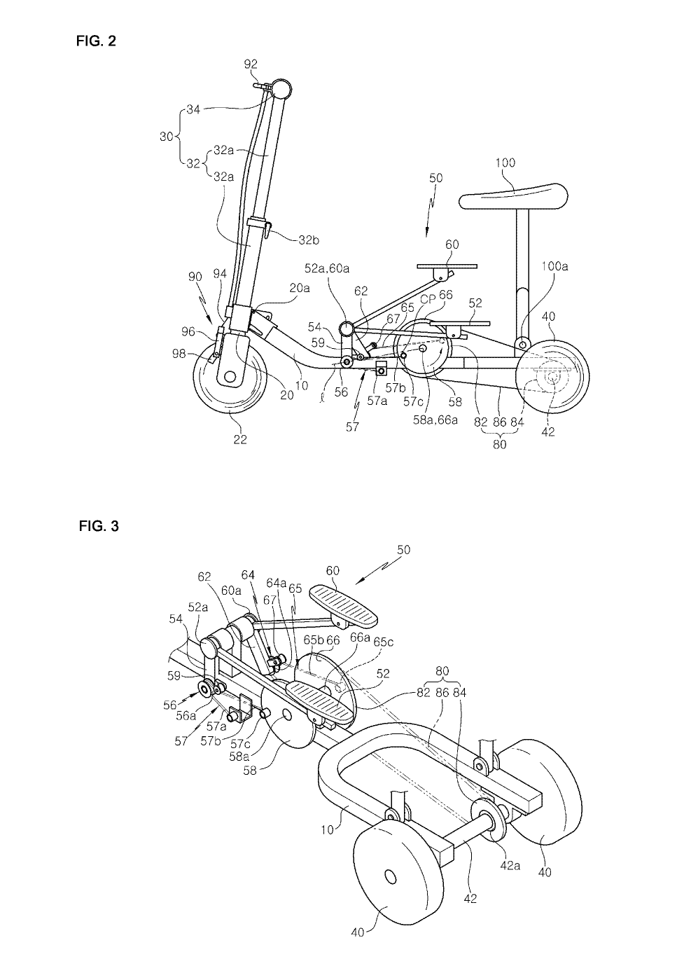

Referring to FIGS. 1 and 2 first, the human-driven traveling apparatus according to an embodiment of the present invention may include a frame 10. A head tube 12 may be disposed at the front portion of the frame 10 and a steering shaft 20 may be rotatably connected to the head tube 12.

A front wheel 22 may be connected to the lower end and a handle 30 may be connected to the upper end of the steering shaft 20. The front wheel 22 may roll on the ground.

The handle 30 may include a handle shaft 32 connected to the steering wheel 20 and a handlebar 34 transversely connected to the upper end of the handle shaft 32.

As a user turns the handlebar 34, the handle 30 may turn the steering shaft 20. Therefore, the front wheel 22 connected to the steering shaft 20 may be steered.

On the other hand, the handle shaft 32 may include a telescopic shape and may be formed by assembling a plurality of shaft segments 32a in multi-steps. The multi-stepped shaft segments 32a may be extended and retracted, if needed. Therefore, it may be possible to fit the height of the handle bar 34 at the upper end to the user's body conditions. After extending and retracting, the multi-steps shaft segments 32a may be fixed by a tightening-lever 32b. As a result, they may be kept extended or retracted.

The steering shaft 20 and the handle shaft 32 may be foldable about a hinge shaft 20a to the frame 10. Therefore, as shown in FIG. 5, the kick board may become portable with the steering shaft 20 and the handle shaft 32 folded to the frame 10. Accordingly, the kick board can be easily carried and stored.

Further, referring to FIGS. 1 to 3, the human-driven traveling apparatus according to an embodiment of the present invention may include rear wheels 40 rotatably disposed at the rear portion of the frame 10.

The rear wheels 40 may roll on the ground and make a pair. The pair of rear wheels 40 may be connected in parallel to both ends of a wheel shaft 42 that may be connected to the frame 10.

Further, referring to FIGS. 1 to 4, the human-driven traveling apparatus according to an embodiment of the present invention may include a pedal assembly 50 that drives the rear wheels 40 at both sides, using the force applied from both of the user's feet.

The pedal assembly 50 may include a first pedal 52 connected to the frame 10 to be rotatable up/down.

The first pedal 52, which the user may step on with their left foot, may rotate up/down about a rotational shaft 52a.

Meanwhile, an arm 54 may be integrally formed at the rotational shaft 52a-sided portion of the first pedal 52. The arm 54 may extend downward from the rotational shaft 52a-sided portion and may include a pulling roller 56 rotatably formed at the end.

The arm 54 may rotate up/down with the up-down rotation of the first pedal 52.

The pulling roller 56 may include a seating groove 56a around the outer circumference and may rotate with the up-down rotation of the arm 54.

Meanwhile, a bendable link member 57 may be seated and supported on the seating groove 56a of the pulling roller 56.

The link member 57 may be implemented by a chain or a steel wire, in which it is wound on the seating groove 56a of the pulling roller 56, with one end 57a fixed to the frame 10, and then the other end 57b connected to a pivot 57c of a first rotary circular plate 58 attached to the frame 10. In this configuration, the pivot 57c may be biased from a rotary center shaft 58a of the first rotary circular plate 58.

As the first pedal 52 is pressed to rotate down by the force applied by the user, the link member 57 may be pulled by the pulling roller 56 attached to the arm 54 of the first pedal 52. Further, the link member 57 pulled by the pulling roller 56 may rotate the first rotary circular plate 58 connected to the other end 57b while pulling it forward. In particular, it may rotate the first rotary circular plate toward the front, in the direction of travel.

In this configuration, a push roller 59 may be rotatably formed at one side of the arm 54. The push roller 59 may push the link member 57, when the first pedal 52 is pressed down. In particular, it may push down the other end 57b of the link member 57.

As the push roller 59 pushes the other end 57b of the link member 57, the pivot 57c of the link member 57 may be further rotated down. As a result, more pulling force of the link member 57 may be applied to the first rotary circular plate 58. Therefore, the rotational force of the first rotary circular plate 58 may increase.

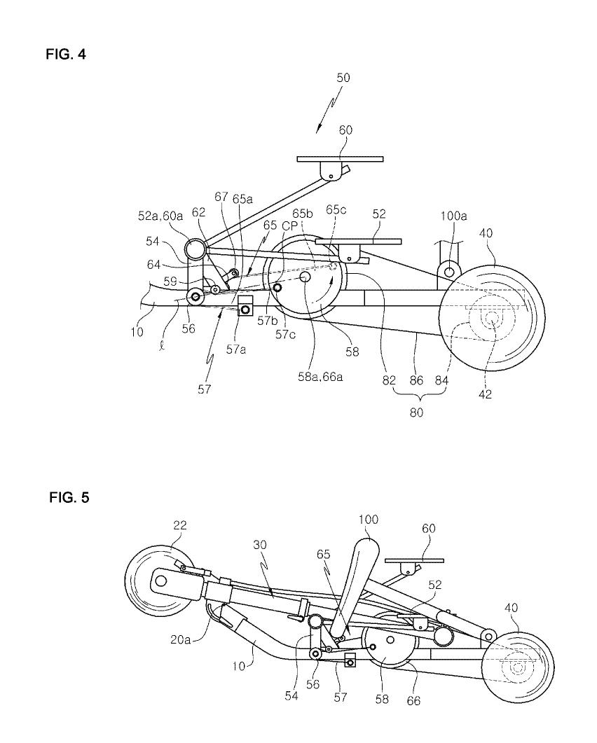

Further, as shown in FIG. 4, since the push roller 59 may further rotate down the pivot 57c of the link member 57, the position of the pivot 57c may move down. In particular, the position maybe moved under a change point CP on the line (l) connecting the pulling roller 56 with the rotational center shaft 58a of the first rotary circular plate 58.

Accordingly, when the rotational force of a second pedal 60 (described below) is continually applied to the first rotary circular plate 58, the first rotary circular plate 58 may be prevented from reversing. Therefore, the first rotary circular plate 58 may keep rotating in the normal direction.

The first rotary circular plate 58 may be connected to the frame 10 to be rotatable about the rotational center shaft 58a. The first rotary circular plate 58 may be operationally connected with the first pedal 52 through the link member 57 and the arm 54. The first rotary circular plate 58 connected as described above may rotate in the direction of travel, when the user presses down the first pedal 52.

On the other hand, although the link member 57 may be wound around the pulling roller 56 of the arm 54 and may connect the arm 54 with the first rotary circular plate 58 in the above description and the figures, if needed, the link member 57 may directly connect the arm 54 with the first rotary circular plate 58.

In this case, as the user presses and rotates down the first pedal 52, the link member 57 may be directly pulled by the arm 54 of the first pedal 52 and directly rotate forward the first rotary circular plate 58.

Referring to FIGS. 1 to 4 again, the pedal assembly 50 may include the second pedal 60 connected to the frame 10 to be rotatable up/down.

The second pedal 60 that the user may step on with their right foot may be disposed to correspond to the first pedal 52 and rotate up/down about a rotary shaft 60a. The rotary shaft 60a of the second pedal 60 may be disposed coaxially with the rotary shaft 52a of the first pedal 52.

An arm 62 may be integrally disposed at the rotary shaft 60a-sided portion. The arm 62 may extend downward from the rotary shaft 60a and may include a rotatable pulling roller 64 at the end.

The arm 62 may rotate up/down with the up-down rotation of the second pedal 60.

The pulling roller 64 may include a seating groove 64a formed around the outer circumference and rotate with the up-down rotation of the arm 62.

Meanwhile, a bendable link member 65 may be seated and supported in the seating groove 64a of the pulling roller 64.

The link member 65 may be implemented by a chain or a steel wire, in which it may be wound on the seating groove 64a of the pulling roller 64, with one end 65a fixed to the frame 10, and then the other end 65b connected to a pivot 65c of the second rotary circular plate 66 attached to the frame 10. In this configuration, the pivot 65c may be biased from a rotary center shaft 66a of the second rotary circular plate 66.

As the second pedal 60 is pressed to rotate down by the force applied by the user, the link member 65 may be pulled by the pulling roller 64 attached to the arm 62 of the second pedal 60. Further, the link member 65 pulled by the pulling roller 64 may rotate the second rotary circular plate 66 connected to the other end 65b while pulling it forward. In particular, it may rotate the first rotary circular plate toward the front, in the direction of travel.

In this configuration, a push roller 67 may be rotatably formed at one side of the arm 62. The push roller 67 may operate in the same way as the push roller 59 of the first pedal 52, that is, pushes down the other end 65b of the link member 65, when the second pedal 60 is pressed down.

The pivot 65c of the link member 65 may be further rotated down. As a result, the pulling force of the link member 65 may be more applied to the second rotary circular plate 66.

Further, since the push roller 67 may further rotate down the pivot 65c of the link member 65, the position of the pivot 65c may move under a change point CP (see FIG. 4).

Accordingly, when the rotational force of the first pedal 52 is continually applied to the second rotary circular plate 66, the second rotary circular plate 66 may be prevented from reversing. Therefore, the second rotary circular plate 66 may keep rotating in the normal direction.

The second rotary circular plate 66 may be connected to the frame 10 to be rotatable about the rotational center shaft 66a. The second rotary circular plate 66 may be operationally connected with the second pedal 60 through the link member 65 and the arm 62. The second rotary circular plate 66 connected as described above may rotate in the direction of travel, when the user presses down the second pedal 60.

Meanwhile, the rotational center shaft 58a of the first rotary circular plate 58 may be disposed coaxially with the rotational center shaft 66a of the second rotary circular plate 66. The rotational center shafts 58a and 66a of the first rotary circular plate 58 and the second rotary circular plate 66, which may be positioned on the same axis, may be integrally connected. The rotational center shafts 58a and 66a connected as described above may integrally connect the first rotary circular plate 58 with the second rotary circular plate 66. Therefore, the first rotary circular plate 58 may rotate integrally with the second rotary circular plate 66.

Further, referring to FIG. 4, it may be preferable that the pivot 57c of the link member 57 for the first rotary circular plate 58 be symmetrically positioned to the pivot 65c of the link member 65 for the second rotary circular plate 66, with the rotational center shafts 58a and 66a therebetween.

This may be because the force of the link member 57 rotating the first rotary circular plate 58 and the force of the link member 65 rotating the second rotary circular plate 66 may be alternately applied without interference, only when the pivot 57c of the link member 57 for the first rotary circular plate 58 may be symmetric to the pivot 65c of the link member 65 for the second rotary circular plate 66. Accordingly, in this case, the user may continuously input force while alternately pressing down the first pedal 52 and the second pedal 60.

Further, this may be because any one of the link members 57 and 65 may pull and rotate forward the corresponding rotary circular plate 58, while the other may pull rearward the pulling roller 64 while being pulled rearward by the rotational force of the corresponding rotary circular plate 66, only when the pivot 57c of the link member 57 for the first rotary circular plate 58 may be symmetric to the pivot 65c of the link member 65 for the second rotary circular plate 66.

Accordingly, as any one of the first pedal 52 and the second pedal 60 moves down, the other may move up, and as a result, the first pedal 52 and the second pedal 60 may alternately move. Therefore, the user may press down alternately the first pedal 52 and the second pedal 60.

On the other hand, although the link member 65 may be wound around the pulling roller 64 of the arm 62 and connect the arm 62 with the second rotary circular plate 66 in the above description and the figures, if needed, the link member 65 may directly connect the arm 62 with the second rotary circular plate 66.

In this case, as the user presses and rotates down the second pedal 60, the link member 65 may be directly pulled by the arm 62 of the second pedal 60 and directly rotate forward the second rotary circular plate 66.

Referring to FIGS. 1 to 4 again, the pedal assembly 50 may include a chain power transmission assembly 80 transmitting the rotational force of the first and second rotary circular plate 58 and 66 to both rear wheels 40.

The chain power transmission assembly 80 may include sprocket teeth 82 formed around any one of the first and second rotary circular plate 58 and 66, a wheel shaft 42 connecting both rear wheels 40, a driven sprocket 84 fitted on the wheel shaft 42, and a chain 86 linking the sprocket teeth 82 with the driven sprocket 84.

The chain power transmission assembly 80 may transmit the driving force of the first and second rotary circular plates 58 and 66 to both rear wheels 40 through the sprocket teeth 82, the chain 86, the driven sprocket 84, and the wheel shaft 42. Accordingly, both rear wheels 40 may simultaneously rotate. As a result, the kick board of the present invention may travel forward by both rear wheels 40 rotating at the same speed.

On the other hand, a ratchet may be disposed between the driven sprocket 84 and the wheel shaft 42. The ratchet 42a, a device transmitting power in only one direction, may transmit only the rotational force of the driven sprocket 84, which may rotate forward in the normal direction, to the wheel shaft 42. The ratchet 42a is widely known in the art as being used for bicycles and the detailed description is not provided.

Referring to FIGS. 1 and 2 again, the human-driven traveling apparatus may include a brake system 90 braking the front wheel 22.

The brake system 90 may include a brake lever 92 that may be connected to the handlebar 34 to be turned when the user grips it, a cable 94 that may be pulled by the brake lever 92 turned, an X-shaped link 96 that may be moved across each other by the pulled cable 94 such that both ends may gradually come close to both sides of the front wheel 22, and brake shoes 98 that may be fixed to both ends of the X-shaped link 96 to be in frictional contact to both sides of the front wheel 22.

In particular, as both ends of the X-shaped link 96 may come close to both sides of the front wheel 22, the brake shoes 98 may come in frictional contact to both sides of the front wheel 22 to brake the front wheel 22.

Since the brake system 90 may brake the front wheel 22 when the user grips the brake lever 92, it may be possible to rapidly and safely brake the kick board when in motion. Therefore, it is possible to rapidly brake the kick board even if a sudden happening occurs when in motion, and accordingly, it is possible to preclude a safety accident due to a sudden happening when in motion.

On the other hand, although it was described that the brake system 90 may brake the front wheel 22 in the figures and the above description of the present invention, if necessary, it is possible to make the brake system brake the rear wheels 40.

Further, referring to FIGS. 1 and 2, the human-driven traveling apparatus may include a seat 100.

The seat 100 may be disposed at the rear portion of the frame 10 for the user to seat. The seat 100 may be adjustable in height. Therefore, it may be possible to adjust the height to fit with the body size of the user.

Meanwhile, the seat 100 may be foldable to the frame 10 about a hinge shaft 100a. Accordingly, as shown in FIG. 5, it may be possible to carry the human-driven traveling apparatus with the seat folded to the frame 10. Therefore, the kick board may be easily carried.

Next, the usage of an embodiment the present invention having the above configuration is described with reference to FIGS. 1 to 4.

First, the user may sit on the seat 100 and press down the first pedal 52 with their left foot. The first pedal 52 may be correspondingly rotated downward by the force applied to the first pedal 52.

Further, as the first pedal 52 rotates downward, the arm 54 may correspondingly rotate, and the rotation of the arm 54 may pull forward the link member 57 connected to the pulling roller 56 of the arm 54. Furthermore, the link member 57 pulled forward may press and rotate forward the first rotary circular plate 58.

Further, the rotational force of the first rotary circular plate 58 rotating forward may be transmitted to the wheel shaft 42 through the sprocket teeth 82, the chain 86, and the driven sprocket 84. Further, the wheel shaft 42 that may receive the driving force rotates both rear wheels 40. Accordingly, both rear wheels 40 may rotate at the same speed and the kick board may be propelled forward by the rear wheels 40 rotating.

On the other hand, as shown in FIGS. 3 and 4, as the first rotary circular plate 58 may be rotated by the first pedal 52 pressed down, the second rotary circular plate 66 may be correspondingly rotated, in which the rotational force of the second rotary circular plate 66 may be exerted to pull rearward the link member 65.

As a result, the link member 65 may be pulled rearward, and the link member 65 pulled rearward may pull rearward the pulling roller 64 of the arm 62. Accordingly, the second pedal 60 connected with the arm 62 may be rotated upward. Therefore, the second pedal 60 may move up for the user to step thereon.

The link member 65 may be stretched straight when being pressed down by the push roller 67, and the link member 65 stretched straight may attenuate the pulling force transmitted from the second rotary circular plate 66 to the arm 62. As a result, the pulling angle of the arm 62 may be decreased. Accordingly, the height of the pedal 60 moving up may also be decreased. Therefore, the height of second pedal 60 moving up may be decreased such that the user is comfortable to step on the pedal.

Meanwhile, as the user presses down the second pedal 60 moving up with their right foot, the force may be transmitted to both rear wheels 40 through the same path as the first pedal 52 which is described above. As a result, the kick board may be propelled forward by both rear wheels 40 rotating at the same speed.

In this operation, when the second pedal 60 is pressed down, the first pedal 52 may be moved up again by the interaction with the first pedal 52 described above, and as the first pedal 52 moving up is pressed down again, the second pedal 60 may be moved up again.

As a result, the first pedal 52 and the second pedal 60 are may be alternately moved up by the interaction between the pedals. Further, the user may continuously apply force by alternately pressing down the first pedal 52 and the second pedal 60 that alternately move up. Therefore, the kick board may be continuously propelled.

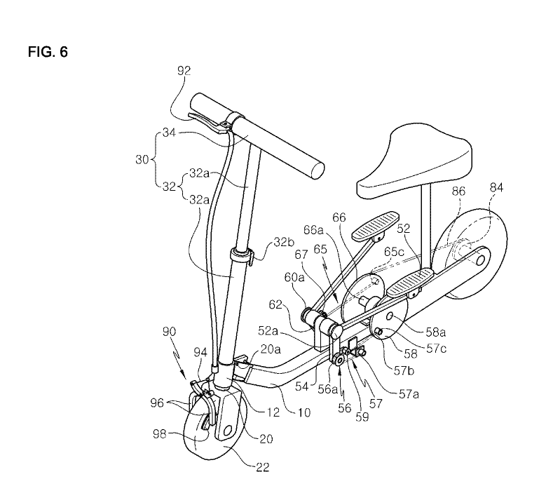

Next, FIG. 6 is a view showing another embodiment of a human-driven traveling apparatus according to the present invention.

The human-driven traveling apparatus according to this embodiment may be characterized by including one rear wheel 40. The rear wheel 40 may be aligned with the front wheel 22.

This embodiment of the present invention may be different in the configuration having one rear wheel 40 and other configurations may be the same as the embodiment described above.

Although preferred embodiments of the present invention were described above, the scope of the present invention is not limited to the embodiments and may be appropriately modified within the scope described in claims. For example, any one may be applied, as long as the apparatus of the present invention may be manually driven. For example, the present invention may be applied to bicycles.

1. A human-driven traveling apparatus, comprising:
a frame;
a front wheel disposed at the front portion of the frame;
a handle for steering the front wheel;
rear wheels disposed at the rear portion of the frame; and
a pedal assembly driving the rear wheels, using force inputted from both feet of a user,
wherein the pedal assembly includes:
first and second pedals connected to the frame to be rotatable up/down for the user to presses down with both feet, respectively;
first and second rotary circular plates rotatably connected to the frame;
a first power transmission mechanism transmitting rotational force of the first pedal rotated by the force applied by the user, to the first rotary circular plate;
a second power transmission mechanism transmitting rotational force of the second pedal rotated by the force applied by the user, to the second rotary circular shaft; and
a third power transmission mechanism transmitting the rotational force of the first and second rotary circular plates to the rear wheels to drive the rear wheel.

2. The human-driven traveling apparatus according to claim 1, wherein the first power transmission mechanism includes:
an arm extending from the rotary shaft-sided portion of the first pedal to rotate with the first pedal; and
a link member connecting the arm with the first rotary circular plate to rotate the first rotary circular plate while being pulled by the arm rotating with the first pedal.

3. The human-driven traveling apparatus according to claim 2, wherein the link member is bendable and has one end fixed to the frame and the other end connected to a pivot of the first rotary circular plate,
a pulling roller is provided to the arm to wind the middle portion of the link member, and
the pulling roller pulls the link member to rotate the first rotary circular plate while rotating with the arm.

4. The human-driven traveling apparatus according to claim 3, further comprising a push roller provided to the first pedal to push the other end of the link member in the rotational direction of the first rotary circular plate, when the first pedal is rotated by the force applied by the user.

5. The human-driven traveling apparatus according to claim 1, wherein the second power transmission mechanism includes:
an arm extending from the rotary shaft-sided portion of the second pedal to rotate with the second pedal; and
a link member connecting the arm with the second rotary circular plate to rotate the second rotary circular plate while being pulled by the arm rotating with the second pedal.

6. The human-driven traveling apparatus according to claim 5, wherein the link member is bendable and has one end fixed to the frame and the other end connected to a pivot of the second rotary circular plate,
a pulling roller is provided to the arm to wind the middle portion of the link member, and
the pulling roller pulls the link member to rotate the second rotary circular plate while rotating with the arm.

7. The human-driven traveling apparatus according to claim 6, wherein further comprising a push roller provided to the second pedal to push the other end of the link member in the rotational direction of the second rotary circular plate, when the second pedal is rotated by the force applied by the user.

8. The human-driven traveling apparatus according to claim 3, wherein the link member is any one selected from a chain and a steel wire.

9. The human-driven traveling apparatus according to claim 1, wherein the first rotary circular plate and the second rotary circular plate include the same rotational center shafts to rotate with each other, and
the third power transmission mechanism includes sprocket teeth formed around any one of the first and second rotary circular plates, a driven sprocket fitted on a wheel shaft for the rear wheels, and a chain linking the sprocket teeth with the driven sprocket.

10. The human-driven traveling apparatus according to claim 9, having a structure in which any one of the first and second pedals is pressed down and a corresponding link member is pulled and rotates a corresponding rotary circular plate, while the other link member is pulled by a corresponding rotary circular plate and presses upward a corresponding pedal.

11. The human-driven traveling apparatus according to claim 1, wherein a seat for the user to sit is disposed on the frame, and the handle and the seat are foldable connected to the frame.

12. The human-driven traveling apparatus according to claim 4, wherein the link member is any one selected from a chain and a steel wire.

13. The human-driven traveling apparatus according to claim 5, wherein the link member is any one selected from a chain and a steel wire.

14. The human-driven traveling apparatus according to claim 6, wherein the link member is any one selected from a chain and a steel wire.

15. The human-driven traveling apparatus according to claim 7, wherein the link member is any one selected from a chain and a steel wire.

16. The human-driven traveling apparatus according to claim 2, wherein the first rotary circular plate and the second rotary circular plate include the same rotational center shafts to rotate with each other, and
the third power transmission mechanism includes sprocket teeth formed around any one of the first and second rotary circular plates, a driven sprocket fitted on a wheel shaft for the rear wheels, and a chain linking the sprocket teeth with the driven sprocket.

17. The human-driven traveling apparatus according to claim 3, wherein the first rotary circular plate and the second rotary circular plate include the same rotational center shafts to rotate with each other, and
the third power transmission mechanism includes sprocket teeth formed around any one of the first and second rotary circular plates, a driven sprocket fitted on a wheel shaft for the rear wheels, and a chain linking the sprocket teeth with the driven sprocket.

18. The human-driven traveling apparatus according to claim 5, wherein the first rotary circular plate and the second rotary circular plate the same rotational center shafts to rotate with each other, and
the third power transmission mechanism includes sprocket teeth formed around any one of the first and second rotary circular plates, a driven sprocket fitted on a wheel shaft for the rear wheels, and a chain linking the sprocket teeth with the driven sprocket.

19. The human-driven traveling apparatus according to claim 6, wherein the first rotary circular plate and the second rotary circular plate include the same rotational center shafts to rotate with each other, and
the third power transmission mechanism includes sprocket teeth formed around any one of the first and second rotary circular plates, a driven sprocket fitted on a wheel shaft for the rear wheels, and a chain linking the sprocket teeth with the driven sprocket.

20. The human-driven traveling apparatus according to claim 16, having a structure in which any one of the first and second pedals is pressed down and a corresponding link member is pulled and rotates a corresponding rotary circular plate, while the other link member is pulled by a corresponding rotary circular plate and presses upward a corresponding pedal.

21. The human-driven traveling apparatus according to claim 17, having a structure in which any one of the first and second pedals is pressed down and a corresponding link member is pulled and rotates a corresponding rotary circular plate, while the other link member is pulled by a corresponding rotary circular plate and presses upward a corresponding pedal.

22. The human-driven traveling apparatus according to claim 18, having a structure in which any one of the first and second pedals is pressed down and a corresponding link member is pulled and rotates a corresponding rotary circular plate, while the other link member is pulled by a corresponding rotary circular plate and presses upward a corresponding pedal.

23. The human-driven traveling apparatus according to claim 19, having a structure in which any one of the first and second pedals is pressed down and a corresponding link member is pulled and rotates a corresponding rotary circular plate, while the other link member is pulled by a corresponding rotary circular plate and presses upward a corresponding pedal.
